(19) United States
(12) Patent Application Publication
(10) Pub. No.: US 2026/0210062 A1
(43) Pub. Date: Jul. 23, 2026

(54) SELF-PROPELLED GROUND COMPACTOR

(71) Applicant: Hamm AG, Tirschenreuth (DE)

(72) Inventors: Marco KREGER, Tirschenreuth (DE); Jürgen HOPF, Tirschenreuth (DE)

(21) Appl. No.: 19/453,070

(22) Filed: Jan. 20, 2026

(30) Foreign Application Priority Data
Jan. 22, 2025 (DE) 10 2025 102 188.0

(51) Int. Cl. E01C 19/23; B60K 11/02; E01C 19/26

(52) U.S. Cl. CPC E01C 19/238; B60K 11/02; E01C 19/26

(57) ABSTRACT

A self-propelled ground compactor includes a front carriage and a rear carriage pivotally connected to the front carriage for steering the ground compactor. A drive unit and a cooling system are provided on the front carriage. The cooling system includes at least one cooler through which a medium to be cooled and cooling air can flow, and a cooling air blower. At least one cooler is arranged on a rear side of the front carriage facing the rear carriage in such a way that the cooling air flowing through the at least one cooler arranged on the rear side of the front carriage facing the rear carriage exits from the at least one cooler arranged on the rear side of the front carriage facing the rear carriage towards the rear carriage.

The present invention relates to a self-propelled ground compactor.

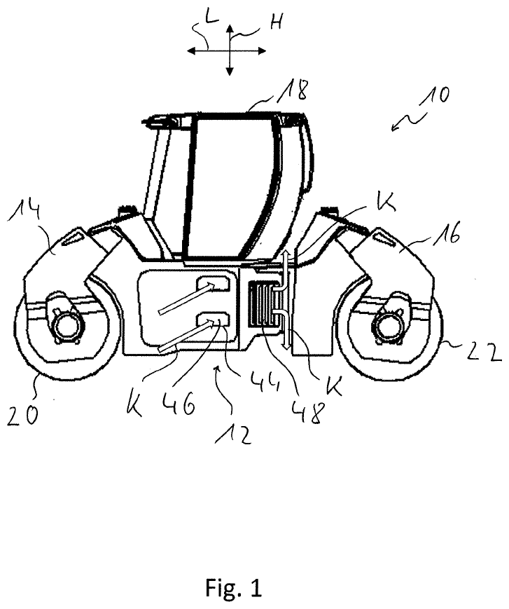

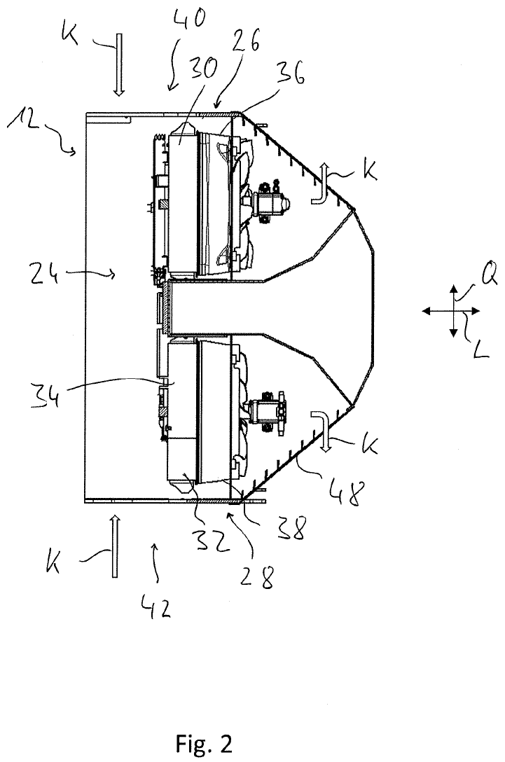

A self-propelled ground compactor sold by Hamm AG under the HD+ series is shown in FIGS. 1 and 2. This self-propelled ground compactor 10, designed as a so-called tandem roller, has a machine frame 12 with two system regions generally arranged successively in a ground compactor longitudinal direction L and designated for the purposes of the present invention as front carriage 14 and rear carriage 16. The front carriage 14 and the rear carriage 16 are pivotably connected to each other about a steering axis extending essentially in a ground compactor height direction H, so that the ground compactor 10 can be steered by pivoting the front carriage 14 and the rear carriage 16 relative to each other.

On the front carriage 14, an operator station, generally designated 18, is arranged, in which an operator of the ground compactor can be positioned. In the ground compactor 10 shown in FIG. 1, the operator station 18 is oriented such that when moving in a forward direction in the ground compactor longitudinal direction L, i.e. to the left in FIG. 1, the operator also looks in this direction. This is a direction of movement of the ground compactor, which it may exhibit, for example, during transfer travels. For compacting ground material, for example asphalt, the ground compactor 10 generally moves back and forth in the ground compactor longitudinal direction L, so that a direction of movement to the right in FIG. 1 is generally referred to as reverse travel. In principle, the operator station 18 could also be arranged rotated by 180° on the machine frame 12 or on the front carriage 14, so that a direction of movement of the ground compactor in FIG. 1 to the right could then be described as the forward direction of travel.

It is therefore evident that the terms chosen for the system regions of the machine frame 12 designated as front carriage 14 and rear carriage 16 primarily serve to distinguish them conceptually from one another, but do not introduce any restriction as to the direction in which such a ground compactor 10 is primarily moved or, for example, during transport travels.

Furthermore, a drive unit not visible in FIG. 1 is provided on the front carriage 14, which generally comprises a diesel combustion engine and, if the ground compactor 10 is designed as a hybrid machine, may also comprise one or more electric motors. Such a drive unit can drive at least one of the two compactor rollers 20, 22 for rotation. Other system components, such as a vibration generation mechanism or a hydraulic oil circuit through which energy is transferred in the ground compactor 10, can also be operated by the drive unit.

To dissipate heat generated, particularly in the region of the front carriage 14 in the vicinity of the drive unit, the ground compactor 10 comprises a cooling system 24, partially shown in FIG. 2. This system comprises two cooler packages 26, 28 arranged one after the other transversely to the ground compactor longitudinal direction L and thus in a ground compactor transverse direction Q, each with at least one cooler 30, 32, 34 and an associated cooling air blower 36, 38. The cooler 30 of the cooler package 26 can, for example, be a coolant cooler through which a coolant, generally cooling water, circulating through a diesel internal combustion engine is cooled. The cooler 32 of the cooler package 28 can, for example, be an intercooler, and the cooler 34 of the cooler package 28 can, for example, be a hydraulic oil cooler in which the hydraulic oil circulating in a hydraulic oil circuit is cooled.

The cooling air K, which is primarily taken in at the side regions 40, 42 of the front carriage 14, through the cooling air blowers 36, 38 assigned to the two cooler packages 26, 28 is drawn in through the respectively assigned coolers 30 or 32, 34 and then expelled in the ground compactor longitudinal direction L or laterally outwards from the front carriage 14. To receive the cooling air K upstream of the cooler packages 36, 38, cooling air inlet openings 46 can be provided, for example, in the region of step recesses 44, which can be used by an operator to reach the operator station 18. To discharge the cooling air K downstream of the cooler packages 36, 38, slot-like cooling air discharge openings 48 are provided on the front carriage 14. As shown in FIGS. 1 and 2, a portion of the cooling air K, which is generally discharged towards the rear carriage 16, flows from the cooling air discharge openings 48, but after being deflected at the rear carriage 16, also flows upwards into the region of the operator station 18. Particularly when a door or window of the operator station 18 is open, or when the operator station 18 is generally open, this can lead to a considerable strain on the operator due to comparatively warm exhaust air.

The object of the present invention is to provide a self-propelled ground compactor in which the strain on an operator caused by the cooling air flowing through the ground compactor is reduced.

According to the invention, this problem is solved by a self-propelled ground compactor comprising a front carriage and a rear carriage pivotably connected to the front carriage for steering the ground compactor and following the front carriage in a ground compactor longitudinal direction, wherein a drive unit and a cooling system are provided on the front carriage, wherein the cooling system comprises at least one cooler through which a medium to be cooled and cooling air flows, and a cooling air blower, wherein at least one cooler is arranged on a rear side of the front carriage facing the rear carriage such that cooling air flowing through the at least one cooler arranged on the rear side of the front carriage facing the rear carriage exits from the at least one cooler arranged on the rear side of the front carriage facing the rear carriage in the direction of the rear carriage, wherein at least one cooling air intake opening is provided on a front side of the rear carriage facing the front carriage for receiving the cooling air exiting in the direction of the rear carriage, and wherein on a rear side of the rear carriage facing substantially away from the front carriage at least one cooling air discharge opening for discharging the cooling air taken in at the at least one cooling air intake opening is provided.

Since, in the self-propelled ground compactor constructed according to the invention, the heated cooling air emitted from the front carriage is not forced to flow past the rear carriage into the environment, but is instead received in the at least one cooling air intake opening formed on the rear carriage and thus directed away from the region of the front carriage, excessive strain on an operator from cooling air or exhaust air flowing into the region of an operator station provided on the ground compactor is largely avoided. This is also particularly due to the fact that the cooling air flows through the rear carriage from the front to the rear side, i.e., essentially in the ground compactor longitudinal direction, and thus no significant flow deflection occurs when flowing through the rear carriage that would increase flow resistance and cause some of the cooling air exiting the front carriage to flow laterally before entering at least one cooling air intake opening.

In order to support the defined guidance of the cooling airflow emitted from the front carriage towards and through the rear carriage, it is proposed that the at least one cooler located on the rear side of the front carriage facing the rear carriage be arranged essentially centrally on the front carriage in a ground compactor transverse direction that is essentially orthogonal to the ground compactor longitudinal direction. Furthermore, such a central positioning causes noises arising in the region of the cooling system or its various coolers to be dampened by system regions positioned to their side.

The absorption of the cooling airflow in the rear carriage can be further supported by the fact that the cooling air flowing through the at least one cooler arranged on the rear side of the front carriage facing the rear carriage exits the cooler arranged on the rear side of the front carriage facing the rear carriage essentially in the ground compactor longitudinal direction in the direction towards the rear carriage.

A compact design that supports the concentrated supply of cooling air to the at least one cooling air intake opening in the rear carriage can provide that the cooling system comprises a plurality of coolers through which the cooling air flows, and that at least two coolers of the cooling system intended for cooling different media are arranged successively on the rear side of the front carriage facing the rear carriage in the ground compactor longitudinal direction in such a way that the cooling air flows through these coolers one after the other essentially in the direction of the longitudinal axis of the ground compactor.

For example, for efficient cooling of different media to be cooled, the at least two coolers intended for cooling different media may comprise:
a coolant cooler for cooling drive unit coolant,
or/and
an oil cooler for cooling of drive unit oil,
or/and
an intercooler for cooling drive unit charging air,
or/and
a hydraulic oil cooler for cooling hydraulic oil;
or/and
a fuel cooler for cooling drive unit fuel.

To generate the cooling air flow, the cooling system may comprise a cooling air blower arranged upstream of the at least one cooler arranged on the rear side of the front carriage facing the rear carriage, following the cooler arranged downstream, in the ground compactor longitudinal direction, of the at least one cooler arranged on the rear side of the front carriage facing the rear carriage.

If the cooling air blower is located upstream of the at least two coolers intended for cooling different media, arranged successively on the rear side of the front carriage facing the rear carriage in the ground compactor longitudinal direction, the cooling air flow passing through this plurality of coolers can be generated by a single cooling air blower. This results in a cost-effective, compact design and, due to the smaller number of blowers used, also a low acoustic load.

A liquid tank, for example a water tank, may be provided on the rear carriage. It is then preferably provided that:
the liquid tank delimits the at least one cooling air intake opening in a ground compactor vertical direction that is essentially orthogonal to the ground compactor longitudinal direction and/or in at least one direction, preferably both directions, in the ground compactor transverse direction, at least partially,
or/and
the liquid tank delimits the at least one cooling air intake opening in the ground compactor vertical direction or/and in at least one direction, preferably both directions, in the ground compactor transverse direction, at least partially.

The liquid tank thus also forms a component that supports the defined flow guidance of cooling air into or through the rear carriage. Additional housing components can therefore be omitted.

For defined flow guidance through the rear carriage, a cooling air flow channel leading from the at least one cooling air intake opening to the at least one cooling air discharge opening can be provided on the rear carriage, and the liquid tank can delimit the cooling air flow channel at least partially in the ground compactor vertical direction and/or in at least one direction, preferably both directions, in the ground compactor transverse direction.

Furthermore, a compactor roller can be rotatably arranged on the rear carriage about a roller axis of rotation that is essentially orthogonal to the ground compactor longitudinal direction, wherein a roller guard is provided on the rear carriage which extends circumferentially around the roller axis of rotation along a part of an outer circumference of the compactor roller and in the direction of the roller axis of rotation, and which defines a roller receiving space, wherein the roller guard limits the cooling air flow channel in the direction towards the compactor roller.

In this context, it should be noted that such a compactor roller can be designed as a continuous roller in the direction of the roller axis of rotation, as a split roller, or as a plurality of rubber wheels positioned one after the other in the direction of the roller axis of rotation.

To receive cooling air in the front carriage, cooling air inlet openings can be provided on the front carriage at side edge regions oriented essentially transversely to the ground compactor longitudinal direction.

Furthermore, an operator station can be provided on the front carriage, from which an operator can control or operate the ground compactor.

For a compact design, it may be provided that the operator station overlaps at least in regions in the ground compactor longitudinal direction the at least one cooler located on the rear side of the front carriage facing the rear carriage.

At least some of the cooling air inlet openings can be located in the region of step recesses leading to the operator station.

FIG. 1 shows a side view of a self-propelled ground compactor known from the prior art;

FIG. 2 shows a top view of the region of a front carriage of the ground compactor lying under an operator station of the ground compactor of FIG. 1;

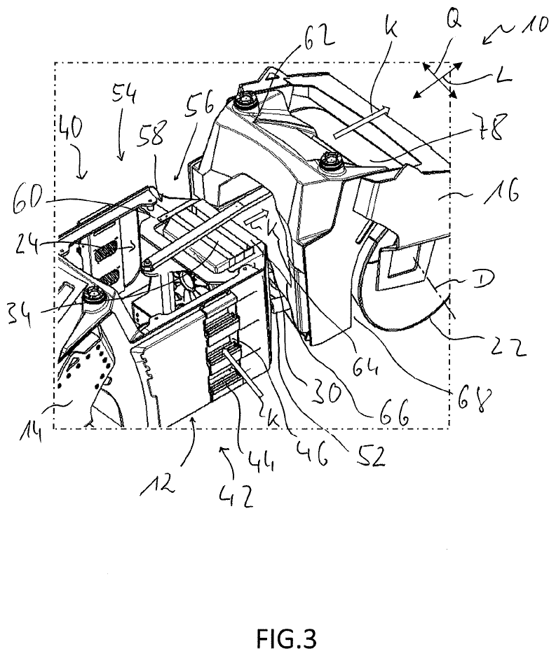

FIG. 3 shows a perspective view of part of a front-rear carriage assembly of a ground compactor constructed according to the invention;

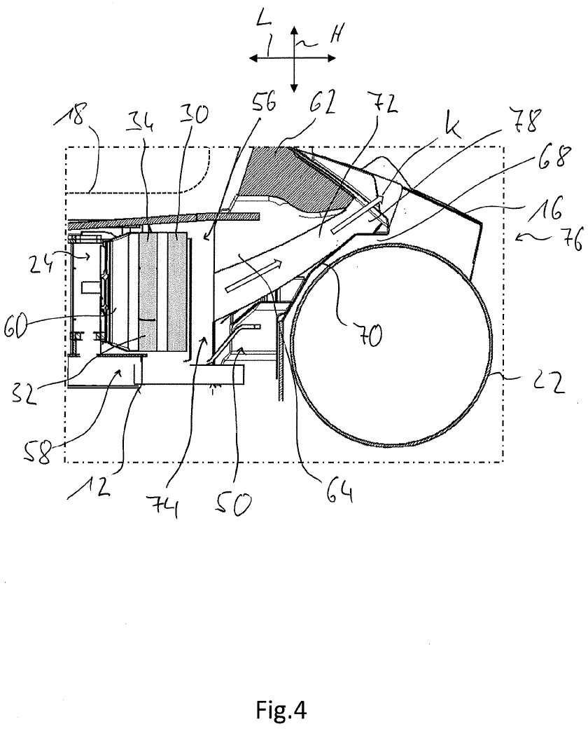

FIG. 4 shows a partially cutaway side view of the front-rear carriage assembly in FIG. 3.

Before the construction of a ground compactor 10 according to the invention is described in detail below with reference to FIGS. 3 and 4, it should be noted that its basic structure can be constructed as shown in FIG. 1. The ground compactor 10 constructed according to the invention can therefore equally comprise a machine frame 12 with a front carriage 14 and a rear carriage 16, wherein a drive unit and an operator station 18 as well as, for example, a compactor roller 20 which can be driven to rotate may be provided on the front carriage 14, while a further compactor roller 22 may be provided on the rear carriage 16 which can be pivoted with respect to the front carriage 14 to steer the ground compactor 10.

With reference to the ground compactor 10 constructed according to the invention, it should also be emphasized that the terms “front carriage” and “rear carriage” or “front” and “rear” serve only to differentiate different system regions of the ground compactor 10 and different directions or orientations and do not represent a restriction in which direction such a ground compactor 10 is to be moved, in particular for carrying out compaction processes.

FIG. 3 shows in its left region the region of the front carriage 14 which is substantially covered by the operator station 18. The step recesses 44 are visible, which can be provided on both sides 40, 42 of the ground compactor, in order to allow an operator to reach the operator station 18 which is positioned above this region of the front carriage 14. Via a pivoting mechanism 50 indicated in principle in FIG. 4 and piston/cylinder units 52 recognizable in FIG. 3, the front carriage 14 and the rear carriage 16 can be pivoted relative to each other about a pivot axis extending essentially in the vertical direction H of the ground compactor in order to steer the ground compactor 10.

A significant system region of the cooling system 24 of the ground compactor 10 is arranged at an end region 54 of the front carriage 14 that is close to the rear carriage 14. In particular, the cooling system 24 comprises a cooler assembly 58 on a rear side 56 of the front carriage 14 facing the rear carriage 16 with multiple coolers 30, 32, 34 arranged successively in the longitudinal direction L of the ground compactor and through which cooling air K flows sequentially. In the cooler assembly 58, the cooler 32, designed as a charge air cooler, and the cooler 34, designed as a hydraulic oil cooler, can be arranged upstream and side by side in the direction of the cooling air flow, and the cooler 30, designed as a coolant cooler, can be arranged downstream of these. Between or upstream or downstream of these coolers 30, 32 or 34, which are positioned consecutively in the ground compactor longitudinal direction L and essentially centrally on the front carriage 14 in the ground compactor transverse direction Q, at least one further cooler can be arranged if required, which can provide a fuel cooler for cooling the diesel fuel. An oil cooler for cooling the drive unit oil of the diesel internal combustion engine of the drive unit can also be provided in the cooler package 58 of coolers arranged successively in the ground compactor longitudinal direction L and thus through which the cooling air K can flow serially. It is important that coolers used to cool more thermally relevant or critical media are located further upstream in the cooling airflow than coolers intended to cool less thermally critical media.

Upstream of the cooler package 58, a single cooling air blower 60 is provided, which draws in the cooling air K, among other things, via the cooling air inlet openings 46 formed in the region of the foot recesses 44 and then conveys it in the form of compressed air through the successively arranged coolers 32, 34, 30. Since only a single cooling air blower 60 is used, not only are installation space and costs saved, but the acoustic load caused by the conveying of cooling air K during the operation of the ground compactor 10 can also be reduced.

As indicated by flow arrows in FIGS. 3 and 4, the cooling air K expelled from the rear side 56 of the front carriage 14 flows essentially in the ground compactor longitudinal direction L towards a cooling air intake opening 64 formed in the rear carriage 16. This is dimensioned and positioned in such a way that it can absorb essentially the entire cooling airflow exiting from the front carriage 14 or the cooler assembly 58, so that essentially no heated cooling air K leaving the front carriage 14 flows laterally past the rear carriage 16.

A liquid tank 62, which is essentially U-shaped when viewed in the ground compactor longitudinal direction L, is provided on the rear carriage 16. This liquid tank 62 can, for example, hold water containing an additive which can be sprayed onto the compactor roller 20 provided on the rear carriage 16 during compaction operation in order to prevent the adhesion of material to be compacted, in particular asphalt material. The liquid tank 62 thus limits the cooling air intake opening 64 on the rear carriage 16 upwards in the ground compactor vertical direction H and in both directions in the ground compactor transverse direction Q, i.e., to the right and to the left in FIG. 3. In the ground compactor vertical direction H downwards, the cooling air inlet opening 64 can be delimited by a frame 66 of the rear carriage 16.

Furthermore, a roller cover 70 is provided on the rear carriage 16, which surrounds in regions an outer circumferential region of the compactor roller 22 and thus defines a roller receiving space 68 for the compactor roller 22. The roller cover 70 extends in the direction of the roller rotation axis D of the compactor roller 22, which is orthogonal to the plane of FIG. 4, essentially over the entire length of the compactor roller 22 and essentially delimits a cooling air flow channel 72 together with the U-shaped liquid tank 62, which leads from the front 74 of the rear carriage 16 facing the front carriage 14 and the cooling air intake opening 64 positioned in this region to a cooling air discharge opening 78 positioned on a rear side 76 of the rear carriage 16 facing away from the front carriage 14.

The cooling air K, which flows out at the rear 56 of the front carriage 14 towards the front 74 of the rear carriage 16, thus enters the cooling air flow channel 72 in the region of the cooling air intake opening 64, flows essentially between the liquid tank 62 and the roller cover 70 in the direction of the cooling air discharge opening 78 positioned at the rear 76 of the rear carriage 16 and leaves the rear carriage 14 or the ground compactor 10 in an region above the compactor roller 22 and essentially with a flow direction in the ground compactor longitudinal direction L or obliquely upwards.

This flow guidance ensures that essentially all of the cooling air K flowing through the front carriage 14 also flows through the rear carriage 16 and thus exits the ground compactor 10 at a distance from the operator station 18, which can essentially completely overlap the cooler package 58 in the ground compactor longitudinal direction L. This prevents comparatively warm cooling air K from entering the region of the operator station 18, even if the ground compactor 10 moves in such a way that the rear carriage 16 is the system region leading in the direction of movement and the front carriage 14 is the system region trailing.

1. A self-propelled ground compactor, comprising a front carriage and a rear carriage pivotally connected to the front carriage for steering the ground compactor, which rear carriage follows the front carriage in a ground compactor longitudinal direction, wherein a drive unit and a cooling system are provided on the front carriage, wherein the cooling system comprises at least one cooler through which a medium to be cooled and cooling air can flow, and a cooling air blower, wherein at least one cooler is arranged on a rear side of the front carriage facing the rear carriage in such a way that the cooling air flowing through the at least one cooler arranged on the rear side of the front carriage facing the rear carriage exits from the at least one cooler arranged on the rear side of the front carriage facing the rear carriage towards the rear carriage, wherein at least one cooling air intake opening is provided on a front side of the rear carriage facing the front carriage for receiving the cooling air to be discharged towards the rear carriage, and wherein at least one cooling air discharge opening for discharging the cooling air received at the at least one cooling air intake opening is provided on a rear side of the rear carriage substantially facing away from the front carriage.

2. The ground compactor according to claim 1,
wherein the at least one cooler arranged on the rear side of the front carriage facing the rear carriage is arranged in a ground compactor transverse direction that is orthogonal to the ground compactor longitudinal direction centrally on the front carriage.

3. The ground compactor according to claim 1,
wherein the cooling air flowing through the at least one cooler arranged on the rear side of the front carriage facing the rear carriage flows in the ground compactor longitudinal direction out of the at least one cooler arranged on the rear side of the front carriage facing the rear carriage in the direction of the rear carriage.

4. The ground compactor according to claim 1,
wherein the cooling system comprises a plurality of coolers, through which the cooling air flows, and in that at least two coolers of the cooling system intended for cooling different media are arranged successively on the rear side of the front carriage facing the rear carriage in the ground compactor longitudinal direction in such a way that the cooling air flows through these coolers one after the other in the direction of the longitudinal axis of the ground compactor.

5. The ground compactor according to claim 4,
wherein the at least two coolers designed to cool different media comprise:
a coolant cooler for cooling the drive unit coolant,
or/and
an oil cooler for cooling drive unit oil,
or/and
an intercooler for cooling drive unit charging air,
or/and
a hydraulic oil cooler for cooling hydraulic oil
or/and
a fuel cooler for cooling drive fuel.

6. The ground compactor according to claim 1,
wherein the cooling system comprises, downstream of the at least one cooler arranged on the rear side of the front carriage facing the rear carriage, a cooling air blower arranged upstream of the at least one cooler arranged on the rear side of the front carriage facing the rear carriage.

7. The ground compactor according to claim 6,
wherein the cooling system comprises a plurality of coolers, through which the cooling air flows, and in that at least two coolers of the cooling system intended for cooling different media are arranged successively on the rear side of the front carriage facing the rear carriage in the ground compactor longitudinal direction in such a way that the cooling air flows through these coolers one after the other in the direction of the longitudinal axis of the ground compactor, and
wherein the cooling air blower is arranged upstream of the at least two coolers provided for cooling different media, which are arranged one after the other in the ground compactor longitudinal direction on the rear side of the front carriage facing the rear carriage.

8. The ground compactor according to claim 1,
wherein a liquid tank is provided on the rear carriage, and
the liquid tank delimits the at least one cooling air intake opening in a ground compactor vertical direction that is orthogonal to the ground compactor longitudinal direction and/or in at least one direction in the ground compactor transverse direction, at least in regions,
or/and
the liquid tank delimits the at least one cooling air intake opening in the ground compactor vertical direction or/and in at least one direction in the ground compactor transverse direction, at least in regions.

9. The ground compactor according to claim 1,
wherein a cooling air flow channel leading from the at least one cooling air intake opening to the at least one cooling air outlet opening is provided on the rear carriage, and that the liquid tank delimits the cooling air flow channel in the ground compactor height direction and/or in at least one direction in the ground compactor transverse direction, at least in regions.

10. The ground compactor according to claim 9,
wherein a compactor roller is arranged on the rear carriage so as to be rotatable about a roller rotation axis that is orthogonal to the ground compactor longitudinal direction, wherein a roller cover is provided on the rear carriage and extends in the circumferential direction around the roller rotation axis along part of an external circumference of the compactor roller and extends in the direction of the roller rotation axis and surrounds a roller housing space, and the roller cover delimits the cooling air flow channel in the direction of the compactor roller.

11. The ground compactor according to claim 1,
wherein cooling air inlet openings are provided on the front carriage on side edge regions oriented transversely to the ground compactor longitudinal direction.

12. The ground compactor according to claim 11, wherein an operator station is provided on the front carriage.

13. The ground compactor according to claim 12,
wherein the operator station overlaps at least in regions in the ground compactor longitudinal direction the at least one cooler located on the rear side of the front carriage facing the rear carriage.

14. The ground compactor according to claim 11,
wherein at least a portion of the cooling air inlet openings is provided in the region of step recesses leading to the operator station.
